(19) United States
(12) Patent Application Publication
(10) Pub. No.: US 2005/0238295 A1
(43) Pub. Date: Oct. 27, 2005

(54) Optical assembly with a sleeve assembly comprising a resin cover and a metal holder easily fitted thereto

(75) Inventor: Ryugen Yonemura, Kanagawa (JP)

Correspondence Address: VENABLE LLP, P.O. BOX 34385, WASHINGTON, DC, 20045-9998, US

(73) Assignee: Sumitomo Electric Industries, Ltd., Osaka (JP)

(21) Appl. No.: 11/094,531

(22) Filed: Mar. 31, 2005

(30) Foreign Application Priority Data
Mar. 31, 2004 (JP) 2004-105305

(51) Int. Cl. G02B 6/36

(52) U.S. Cl. 385/92

(57) ABSTRACT

The present invention to provide an optical assembly that includes an optical device, an alignment member, and a sleeve assembly. The sleeve assembly comprises a sleeve, a holder and a cover. The holder is made of metal, while the cover is made of resin. The holder secures the sleeve and the cover protects the holder with the sleeve therein. In the assembly of the invention, the holder provides a circular groove or a flange in the outer surface thereof, while the cover provides a flange or a circular groove in the inner surface thereof. Therefore, the resin cover enables to fit in the holder by mating the circular groove and the flange.

### BACKGROUND OF THE INVENTION

1. Field of the Invention

The present invention relates to an optical assembly, in particular, an optical assembly having a sleeve assembly that includes a resin cover and a holder easily mated with the cover.

2. Related Prior Art

Conventional optical assembly, in particular an optical device enclosed in a co-axial shaped package, provides a sleeve assembly in the front of the package. The sleeve assembly, which comprises of a sleeve, a holder, a stub and a cover, makes it possible for the optical device to couple in optically with an optical fiber inserted into the sleeve assembly. The sleeve, by receiving the ferrule secured in the distal end of the optical fiber, optically couples the optical device with the optical fiber. The holder secures the stub and the sleeve therein and the cover covers thus assembled holder with the sleeve and the stub. In the conventional module, the cover, made of resin, has holes along the contour thereof and the holder provides latches along the contour thereof. Thus, by mating the latches of the holder with the holes of the cover, the cover and the holder can be assembled.

However, members of the sleeve assembly have cylindrical shape, and in particular, the holder is made of metal, such as stainless steel to reinforce the function of securing the sleeve and the stub. Accordingly, structures disposed along the contour in discrete on the outer surface thereof such as latches provided in the holder, are hard to be formed, thereby preventing the module from saving the cost.

### SUMMARY OF THE INVENTION

Therefore, an object of the present invention is to provide an optical assembly having a sleeve assembly with easily mated cover with a holder.

Therefore, an object of the present invention is to provide an optical assembly having a sleeve assembly with easily mated cover with a holder.

According to the present invention, an optical assembly comprises an optical device, an alignment member attached to the optical device, and a sleeve assembly attached to the alignment member. The sleeve assembly includes a sleeve, a holder, and a cover, all of which are cylindrical member. The holder, may be made of metal, secures the sleeve, while the cover, made of resin, protects the holder with the sleeve. In the present optical assembly, the cover easily fits in the holder. In one embodiment, the holder provides a circular groove or a flange in the outer surface thereof, while the cover provides a flange or a circular groove in the inner surface thereof By mating this groove or flange with the flange or the groove, the cover can easily fit in the holder. In another embodiment, the holder provides a male screw in the outer surface thereof, while the cover provides a female screw in the inner surface thereof. By tightening these screws, the cover can easily fit in the holder.

The sleeve assembly may further include a stub secured in the sleeve or the holder. A coupling fiber to couple the optical device with an optical fiber inserted in the sleeve is positioned in the center of the stub. According to one configuration of the invention, the sleeve may secure the stub, and the holder may hold the sleeve with the stub. In another configuration, the sleeve secures a first portion of the stub, while the holder directly secures the second portion of the stub without inserting the sleeve therebetween. In this configuration, the holder may cover the sleeve with the stub in the first portion of the stub.

The alignment member may have a bore and an end wall to form space into which the optical device is inserted. By sliding the inner surface of the bore on the outer side surface of the optical device, the optical alignment along the optical axis may be carried out between the optical device and the sleeve assembly. While, the optical alignment in a plane intersecting the optical axis may be carried out by sliding the sleeve assembly on the end wall of the alignment member. The alignment member may further provide a lens on the end wall thereof to enhance the optical coupling between the optical device and the optical fiber.

The sleeve of the present invention may be a split sleeve and a rigid sleeve. The optical device may be a transmitting optical assembly in which a light-emitting device such as semiconductor laser diode is installed as the semiconductor optical device, or may be a receiving optical assembly in which a light-receiving device such as semiconductor photodiode is installed as the semiconductor optical device.

### BRIEF DESCRIPTION OF DRAWINGS

FIG. 1 is a side view showing an optical assembly according to the first embodiment of the present invention;

FIG. 2 is an exploded view showing a sleeve assembly, some members are cutaway, applicable to the optical assembly of the present invention;

FIG. 3 is a cross section of the sleeve assembly taken along the line III-III in FIG. 2;

FIG. 4 is an exploded view showing a modified sleeve assembly applicable to the optical assembly of the present invention;

FIG. 5 is a cross section of the sleeve assembly shown in FIG. 4 taken along the line V-V;

FIG. 6 is an exploded view showing another modified sleeve assembly applicable to the present optical assembly;

FIG. 7 is a cross section of the sleeve assembly shown in FIG. 6 taken along the line VII-VII; and

FIG. 8 shows another optical assembly according to the second embodiment of the present invention.

### DESCRIPTION OF PREFERRED EMBODIMENTS

In the following detailed description of the invention, reference is made to the accompanying drawings that form a part hereof. In the drawings, the same numerals describe substantially similar elements throughout the several views. These embodiments are described in sufficient detail to enable those skilled in the art to practice the invention. Other embodiments may be utilized and structural changes may be made without departing from the scope of the present invention. The following detailed description is not to be taken in a limiting sense, and the scope of the present invention is defined only by the appended claims, along with the full scope of equivalents to which such claims are entitled.

(First Embodiment)

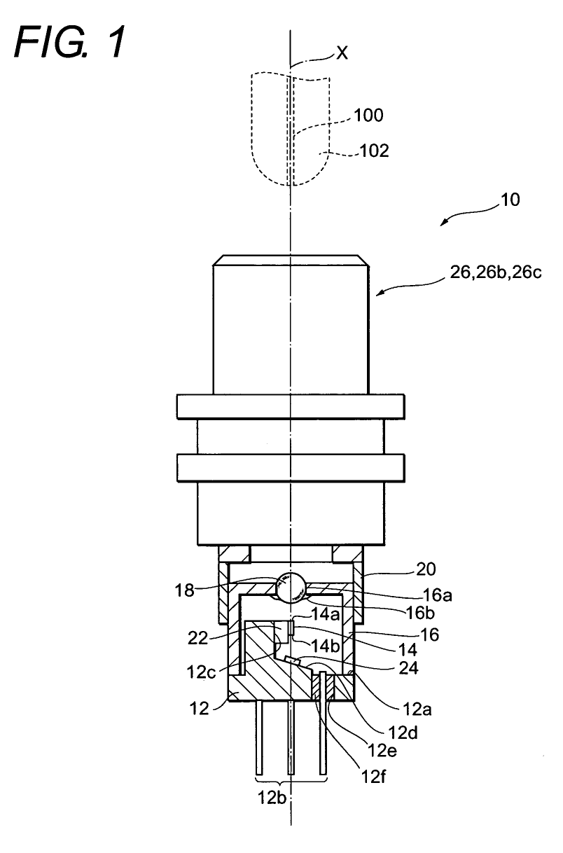

An optical assembly 10 according to the first embodiment of the invention will be described below. FIG. 1 is a side view of the module 10 partially cut to show the inside thereof. The module 10 shown in FIG. 1 is an optical transmitting module, which comprises an optical device, an optical alignment member 20, and a sleeve assembly. The optical alignment member includes a stem 12, a light-emitting device 14, a cap 16, and a lens 18.

The stem 12 includes a primary surface 12a, a plurality of lead pins 12b, a mounting surface 12c, a inclined surface 12d. On the primary surface 12a is provided with a plurality of holes 12e through which the lead pins 12b passing. Seal glass 12f with a low-melting temperature fills the gap between the lead pins 12b and the holes 12e.

The mounting surface 12c intersects a prescribed axis X and supports the light-emitting device 14, such as semiconductor laser diode, through a chip carrier 22. The light-emitting device 14 is electrically connected to one of lead pins 12b. In the present embodiment, the light-emitting device 14 has two surfaces 14a and 14b, i.e. an edge-emitting configuration, where front light is emitted from the first surface 14a along the axis X and back light is emitted from the second surface 14b toward the opposite direction to the front light.

On the inclined surface 12d is mounted with a light-receiving device 24 electrically connected to one of lead pins 12b. In the present arrangement, the light-receiving device 24 receives the back light emitted from the second surface 14b of the light-emitting device 14 and outputs a current signal corresponding to the magnitude of the back light to the lead pin 12b. The inclined surface 12d tilts by an angle to the primary surface 12a of the stem such that the light, reflected by the surface of this light-receiving device, does not reenter the light-emitting device 14, thereby reducing the optical noise.

The cap 16, which is a cylindrical member extending along the axis X, covers the light-emitting device 14 and the light-receiving device 24 therein. One end of the cap 16 is secured on the primary surface 12a of the stem 12 by, for instance the resistance welding. The cap 16 includes an opening 16a in an end portion thereof, into which the lens 18 is secured with seal glass 16 filling the gap between the opening 16a and the lens 18, which hermetically seals the cavity formed by the stem 12, cap 16 and the lens 18, two devices 14 and 24 being enclosed therein.

The alignment member 20 adjusts the focal point of the lens 18 along the axis X to concentrate in proper light emitted from the light-emitting device 14. This alignment member 20 is also a cylindrical member to overlay the cap 16. The alignment member is to be welded, for instance with the YAG-laser welding, to the cap after the alignment therebetween.

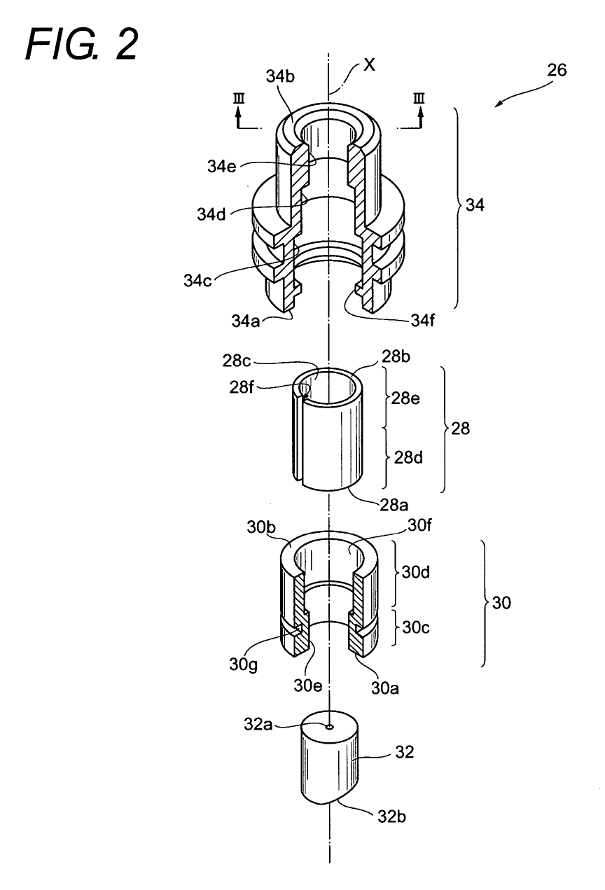

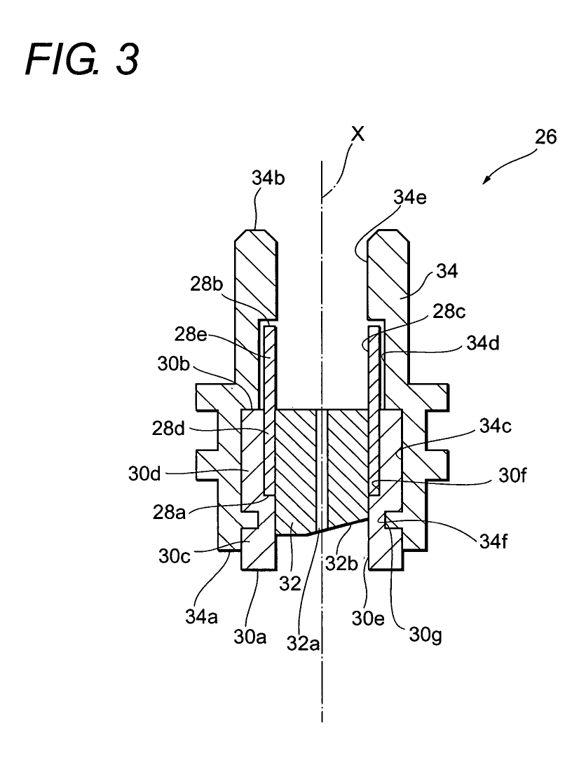

Next, the sleeve assembly 26 according to the present invention will be described. FIG. 2 is an exploded view of the sleeve assembly 26, and FIG. 3 is a cross section taken along the line III-III in FIG. 2. As shown in FIG. 2 and FIG. 3, the sleeve assembly of the embodiment includes a sleeve 28, a holder 30, a stub and a cover 34.

The sleeve 28, also a cylindrical member extending along the axis X between ends 28a and 28b, is made of ceramics such as zirconia. The sleeve 28 has an inner surface 28c, and is divided into two portions 28d and 28e along the axis X, where the former portion 28d is in the side of the end 28a while the latter portion 28e is in the side of the end 28b. The sleeve 28 receives a ferrule 102, to which the optical fiber 100 is secured, in the portion 28e. Specifically, the sleeve 28 secures the ferrule 102 by the inner surface 28c of the portion 28e. The sleeve 28 provides a slit 28f along the axis thereof to facilitate the ferrule 102 inserting into and extracting from. By providing the slit 28f, the sleeve 28 has elasticity toward the radius.

The holder 30 is also a cylindrical member, made of metal, extending along the axis X between two ends 30a and 30b. The end 30a is fixed to the end surface of the alignment member 20 by the YAG-laser welding. The holder 30 is divided into two portions 30c and 30d from the end 30a. Within the bore in the first portion 30c is secured and fixed with the stub 32 that holds a coupling fiber 32a in the center thereof, that is, the inner surface 30e of the bore holds the stub 32. The aforementioned light-emitting device 14 may optically couple with the optical fiber 100 secured in the ferrule 102 through this coupling fiber 32a in the stub 32.

The end 32b of the stub, where the coupling fiber 32a is exposed, is inclined by an angle to the axis X. Accordingly, light emitted from the light-emitting device 14 is not reflected toward the axis X thereat, which reduces the optical noise in the light-emitting device 14. One modification to decrease the light toward the light-emitting device 14 is to provide anti-reflection coating on the end 32b of the stub 32. In this case, the end 32b may be inclined to the axis X or may cross the axis X at right angle.

The second portion 30d of the holder 30 receives the portion 28d of the sleeve within the bore thereof, that is, the inner surface 30f secures the portion 28d of the sleeve 28. On the outer surface of the holder 30 is formed with a circular groove 30g to mate a flange 34f provided in the inner surface of the cover 34 described later.

The cover 34 is, also a cylindrical member extending along the axis X between the ends 34a and 34b thereof, made of resin. The cover 34 includes, along the axis X, first to third inner surface 34c to 34e. Within the bore, defined by the first inner surface 34c, is inserted with a portion of the holder 30. The second inner surface 34d receives the second portion 28e of the sleeve 28. The third inner surface 34e leads the ferrule 102 to the sleeve 28.

As mentioned, the first inner surface 34c provides the flange 34f to mate with the circular groove 30g of the holder 30. Moreover, since the cover 34 is made of resin, the mating between the cover 34 and the holder 30, in particular to mate the flange 34f with the circular groove 30g, may be easily carried out. The circular groove 30g is formed by a ring shape around the outer surface of the holder 30, so the processing thereof may be saved in cost compared with the conventional structure.

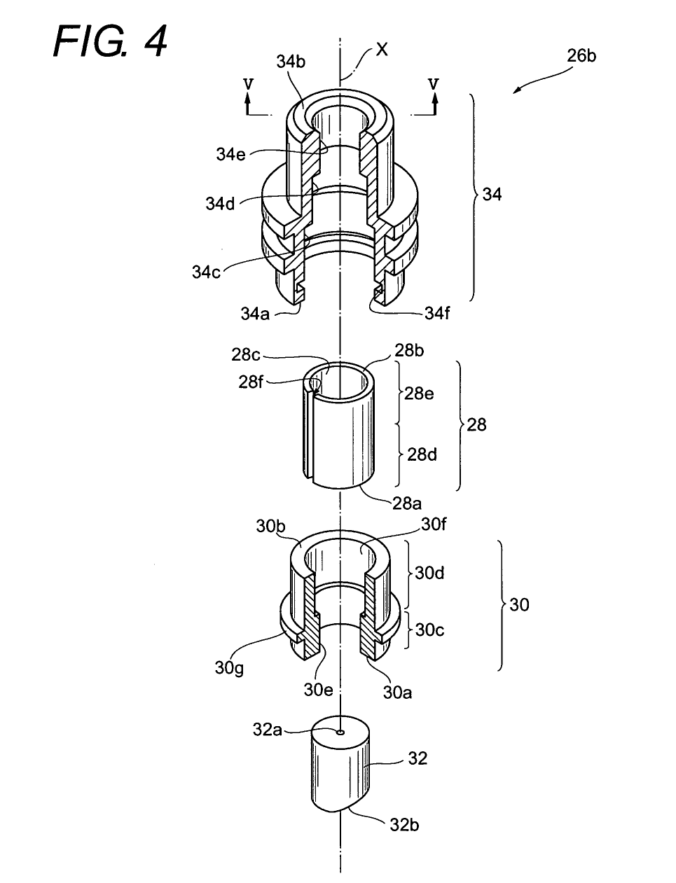

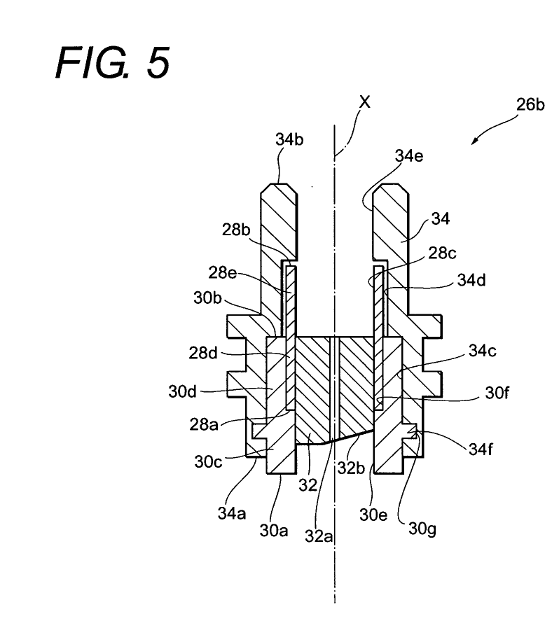

Various modifications for the sleeve assembly 26 may be considered. FIG. 4 is an exploded view, some members being cutaway, showing such modification applicable to the present optical assembly, and FIG. 5 is a cross section of the sleeve assembly 26b taken along the line V-V in FIG. 4. In the assembly 26b, the holder 30 has a flange 30g, instead of the groove, while the cover, which is also made of resin, has a groove 34f in the inner surface thereof. It will be obvious for a person skilled in this field that these arrangement of the flange 30g and the groove 34f show the same function with those shown in FIG. 2 and FIG. 3.

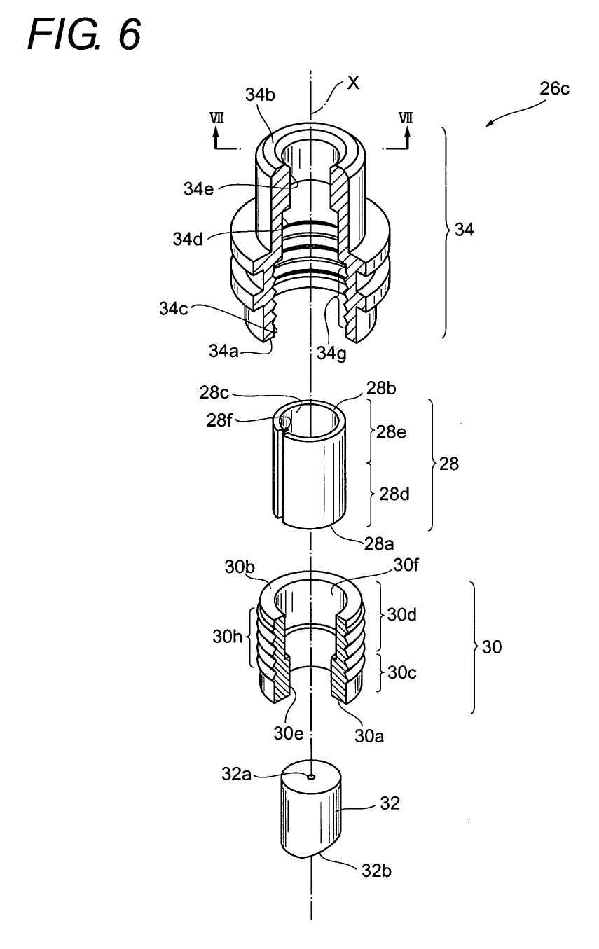

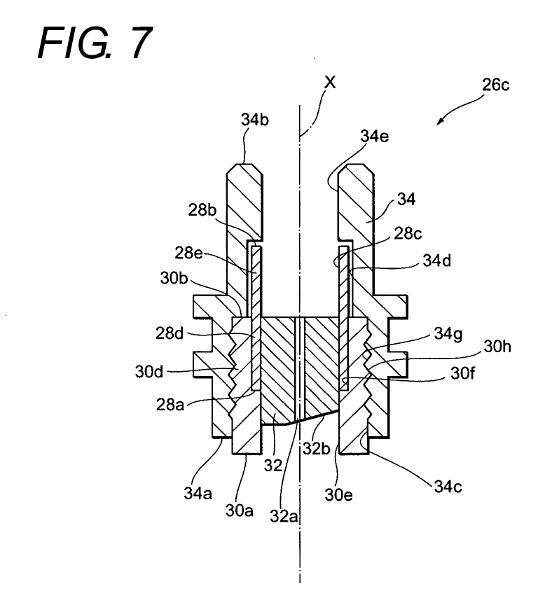

FIG. 6 shows another modification of the sleeve assembly applicable to the present optical assembly. FIG. 7 is a cross section of the sleeve assembly 26c taken along the line VII-VII in FIG. 6. The holder 30 in this embodiment includes s male screw 30h in the outer surface thereof while the cover 34 includes a female screw 34c in the inner surface of the first portion 34c thereof. By mating these male screw 30h and female screw 34c, the cover 34 is held by the holder 30. The cover 34 in this embodiment is also made of resin, and the outer surface of the holder 30, including the male screw 30h thereof may be easily processed by the lathe, which saves the cost of the sleeve assembly 26c.

(Second Embodiment)

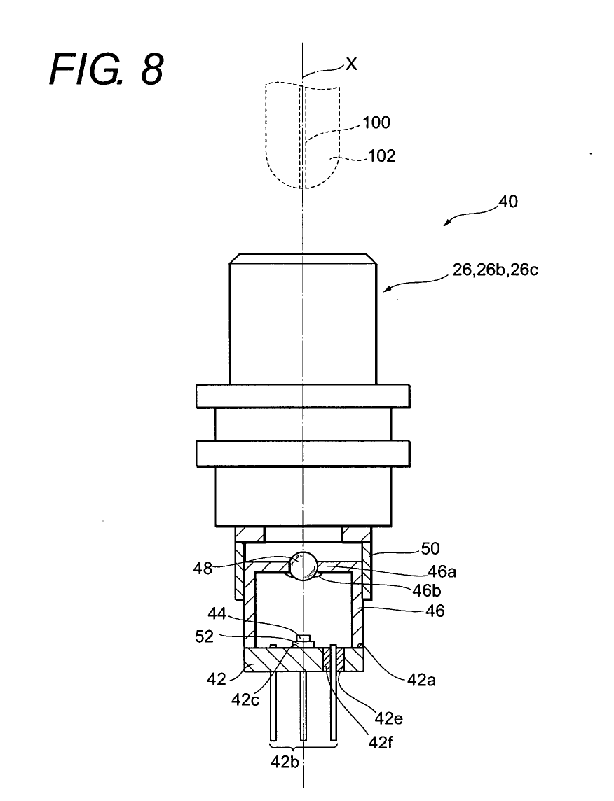

Next, an optical assembly 40 according to the second embodiment of the present invention will be described. FIG. 8 is a side view, partially cutaway view, of the optical assembly 40, which comprises a stem 42, a light-receiving device 44, a cap, a lens, an alignment member 50 and a sleeve. The module of the present embodiment is a light-receiving module.

The stem 42 has a supporting surface 42a, lead pins 42b, and a mounting surface 42c. The supporting surface 42a and the mounting surface 42c extends along a plane intersecting the axis X. The mounting surface 42c mounts the light-receiving device, such as photodiode, via a chip carrier 52. Lead pins 42b pass through holes 42e provided in the stem 42 with seal glass 42f filling the gap between the holes 42e and the lead pins 42b. The light-receiving device 44 is electrically connected to lead pins 42b.

The supporting surface 42a supports the cap 46, which is the same member with the cap 16 of the first embodiment, provides an opening 46a into which the lens 48 is secured with the seal glass filling the gap between the lens 48 and the opening 42a. The alignment member 50 is also same with the member 20 of the first embodiment.

The present optical assembly 40 may also apply the sleeve assemblies 26, 26b and 26c. That is, according to the present invention, the sleeve cover 34 made of resin may be mated with the holder 30 which is easily processed. Thus, the invention may provide a cost saved optical assembly.

Although the invention has been described by way of example and with particularity and specificity, those skilled in the art will recognize that many changes and modifications may be made without departing from the spirit and scope of the invention defined by the claims presented hereinbelow.

1. An optical assembly for installing a semiconductor optical device and optically coupling with an optical fiber secured in an optical connector to be mated with said optical assembly, said optical assembly comprising:
an optical device for installing said semiconductor optical device;
an alignment member attached to said optical device for optically aligning said optical device with said optical fiber; and
a sleeve assembly, attached to said alignment member, for receiving said optical fiber therein, said sleeve assembly including a sleeve for receiving said optical fiber, a holder for covering said sleeve and a cover for covering said sleeve and said holder, said sleeve, said holder and said cover being cylindrical members,
wherein said cover is made of resin and is fitted in said holder.

2. The optical assembly according to claim 1,
wherein said holder is made of metal and has a circular groove in an outer surface, and said cover has a flange in an inner surface to fit with said circular groove of said holder.

3. The optical assembly according to claim 1,
wherein said holder is made of metal and has a flange in an outer surface, and said cover has a circular groove in an inner surface to fit with said flange of said holder.

4. The optical assembly according to claim 1,
wherein said holder is made of metal and has a male screw in an outer surface, and said cover has a female screw in an inner surface to fit said male screw of said holder.

5. The optical assembly according to claim 1,
wherein said sleeve assembly further includes a stub, said sleeve securing said stub therein and said holder securing said sleeve with said stub.

6. The optical assembly according to claim 1,
wherein said sleeve assembly further includes a stub having a first portion and a second portion, said first portion being secured by said sleeve and said second portion being secured by said holder.

7. The optical assembly according to claim 6,
wherein said holder covers said sleeve with said stub in said first portion of said stub.

8. The optical assembly according to claim 1,
wherein said alignment member is a cylindrical member with a bore and an end wall, said optical device being inserted into said bore.

9. The optical assembly according to claim 8,
wherein said alignment member further provide a lens arranged on said end wall of said alignment member.

10. The optical assembly according to claim 1,
wherein said optical assembly is a transmitting optical subassembly including a semiconductor laser diode as said semiconductor optical device.

11. The optical assembly according to claim 1,
wherein said optical assembly is a receiving optical subassembly including a semiconductor photodiode as said semiconductor optical device.

12. The optical subassembly according to claim 1,
wherein said sleeve is a split sleeve.

13. The optical subassembly according to claim 1,
wherein said sleeve is a rigid sleeve.
